(19) United States
(12) Patent Application Publication
(10) Pub. No.: US 2024/0237144 A1
(43) Pub. Date: Jul. 11, 2024

(54) LINK BASED GROUPCAST COMMUNICATION

(71) Applicant: Nokia Technologies Oy, Espoo (FI)

(72) Inventors: Zhijie YANG, Shanghai (CN); Gang CHENG, Shanghai (CN); Yiming JIANG, Shanghai (CN); Mika KASSLIN, Espoo (FI)

(21) Appl. No.: 18/576,807

(22) PCT Filed: Jul. 14, 2021
(86) PCT No.: PCT/CN2021/106268

§ 371 Date: Jan. 5, 2024

(51) Int. Cl. H04W 76/40; H04W 76/11

(52) U.S. Cl. CPC H04W 76/40; H04W 76/11

(57) ABSTRACT

Embodiments of the present disclosure relate to link based groupcast communication. In the solution, a groupcast stream can be delivered on a specified link in a negotiation manner between a first device (e.g., an access point AP in an infrastructure BSS or a mesh station in a mesh BSS) and a second device (e.g., a non-AP station in the infrastructure BSS or a mesh station in the mesh BSS). As such, the waste of radio resources caused by repeated transmission of invalid data on the multiple links are reduces significantly.

### FIELD

Embodiments of the present disclosure generally relate to the field of telecommunication and in particular, to a method, device and computer readable storage medium for link based groupcast (multi-cast) communication.

### BACKGROUND

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more stations (STAs) or mobile devices.

A new feature “multi-link” has been proposed in wireless communication system, according to which an AP or a non-AP STA that supports multi-link can simultaneously manage multiple links working on different channels. For example, two multi-link capable devices may establish multiple links which may operate simultaneously in different frequency bands. However, there is no efficient mechanism of the groupcast communication between the multi-link devices (MLDs).

### SUMMARY

In general, example embodiments of the present disclosure provide a solution for link based groupcast/multi-cast communication.

In a first aspect, there is provided a method for groupcast communication implemented at a first device. The method comprises: transmitting to a second device a request comprising a group address of a groupcast stream and a first identification, the first identification indicating at least one link among a plurality of links available to first device; receiving from the second device a response comprising the group address contained in the request and a second identification indicating at least one link available to the second device: determining whether the first identification matches the second identification; and in accordance with a determination that the first identification matches the second identification, transmitting to the second device the groupcast stream on the at least one link indicated by the first identification.

In a second aspect, there is provided a method for groupcast communication implemented at a second device. The method comprises: receiving from a first device a request comprising a group address of a groupcast stream and a first identification, the first identification indicating at least one link among a plurality of links available to the first device: determining whether the groupcast stream is mapped to the first identification: in accordance with a determination that the data stream is mapped to the first identification, transmitting to the first device a response comprising the group address and the first identification contained in the request: and receiving from the first device the groupcast stream on the at least one link indicated by the first identification.

In a third aspect, there is provided a first device. The first device comprises at least one processor: and at least one memory including computer program code: where the at least one memory and the computer program code are configured to, with the at least one processor, cause the first device at least to transmit to a second device a request comprising a group address of a groupcast stream and a first identification, the first identification indicating at least one link among a plurality of links available to first device: receive from the second device a response comprising the group address contained in the request and a second identification indicating at least one link available to the second device: determine whether the first identification matches the second identification; and in accordance with a determination that the first identification matches the second identification, transmitting to the second device the groupcast stream on the at least one link indicated by the first identification.

In a fourth aspect, there is provided a second device. The second device comprises at least one processor: and at least one memory including computer program code: where the at least one memory and the computer program code are configured to, with the at least one processor, cause the second device at least to receive from a first device a request comprising a group address of a groupcast stream and a first identification, the first identification indicating at least one link among a plurality of links available to the first device: determine whether the groupcast stream is mapped to the first identification: in accordance with a determination that the data stream is mapped to the first identification, transmit to the first device a response comprising the group address and the first identification contained in the request: and receive from the first device the groupcast stream on the at least one link indicated by the first identification.

In a fifth aspect, there is provided an apparatus comprising means for transmitting to a second device a request comprising a group address of a groupcast stream and a first identification, the first identification indicating at least one link among a plurality of links available to first device: means for receiving from the second device a response comprising the group address contained in the request and a second identification indicating at least one link available to the second device: means for determining whether the first identification matches the second identification; and means for in accordance with a determination that the first identification matches the second identification, transmitting to the second device the groupcast stream on the at least one link indicated by the first identification.

In a sixth aspect, there is provided an apparatus comprising means for receiving from a first device a request comprising a group address of a groupcast stream and a first identification, the first identification indicating at least one link among a plurality of links available to the first device: means for determining whether the groupcast stream is mapped to the first identification: means for in accordance with a determination that the data stream is mapped to the first identification, transmitting to the first device a response comprising the group address and the first identification contained in the request: and means for receiving from the first device the groupcast stream on the at least one link indicated by the first identification.

In a seventh aspect, there is provided a non-transitory computer readable medium comprising program instructions for causing an apparatus to perform at least the method according to the first or second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which example embodiments of the present disclosure may be implemented:

FIG. 2 illustrates a schematic diagram of a multi-link communication in the example communication network:

FIG. 3A illustrates a flowchart illustrating a process for groupcast communication according to some example embodiments of the present disclosure:

FIG. 3B illustrates a flowchart illustrating a process for groupcast communication according to some example embodiments of the present disclosure:

FIG. 3C illustrates a flowchart illustrating a process for groupcast communication according to some example embodiments of the present disclosure:

FIG. 4A illustrates an example structure of a groupcast with retries add block acknowledgement (GCR ADD BA) request according to some example embodiments of the present disclosure:

FIG. 4B illustrates an example structure of a groupcast with retries add block acknowledgement (GCR ADD BA) response according to some example embodiments of the present disclosure:

FIG. 4C illustrates an example structure of a groupcast with retries delete block acknowledgement (GCR DEL BA) frame according to some example embodiments of the present disclosure:

FIG. 5 illustrates a flowchart of a method implemented at a first device according to some example embodiments of the present disclosure:

FIG. 6 illustrates a flowchart of a method implemented at a second device according to some example embodiments of the present disclosure:

FIG. 7 illustrates a simplified block diagram of an apparatus that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry), and
(b) combinations of hardware circuits and software, such as (as applicable):
   (i) a combination of analog and/or digital hardware circuit(s) with software/firmware, and
   (ii) any portions of hardware processor(s) with software (including digital signal processor(s), software, and memory(ies) that work together to cause an apparatus, such as a mobile phone or server, to perform various functions), and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Conventionally, in a communication between an AP MLD and a non-AP MLD in an infrastructure basic service set (BSS), group addressed data frames are duplicated on all links on the AP MLD side so that the non-AP MLD can receive the data frames on any of the links. Similarly, in a communication between mesh STAs in a mesh BSS, group addressed data frames are also duplicated on all links. Many useless data frames will be sent due to the duplication on all links, which occupies too many radio resources

According to embodiments of the present disclosure, there is providing a solution for link based groupcast communication. In the solution, a groupcast stream can be delivered on a specified link in a negotiation manner between a first device (e.g., an access point AP in an infrastructure BSS or a mesh station in a mesh BSS) and a second device (e.g., a non-AP station in an infrastructure BSS or a mesh station in a mesh BSS). As such, the waste of radio resources caused by repeated transmission of invalid data on the multiple links are reduces significantly.

Principle and embodiments of the present disclosure will be described in detail below with reference to the accompanying drawings. Reference is first made to FIG. 1, which illustrates an example communication system 100 in which example embodiments of the present disclosure may be implemented.

The system 100 includes a plurality of APs 110-1, 110-2 and 110-3 (individually or collectively referred to as AP 110), which consisting a mesh network. The AP 110-1 acts as a gateway AP node, and is connected to the WAN 105. The APs 110-2 and 110-3 act as agent AP nodes, and are connected to the gateway AP 110-1 for example through wireless communication. Further, each of the APs 110-1, 110-2 and 110-3 may also act as an AP device in an infrastructure BSS and may be connected to one or more non-AP STAs 120.

As an example, the APs 110-1, 110-2 and 110-3 may be deployed in a house, and the gateway AP 110-1 may obtain IPTV service from service provider via the internet connection. The two agent APs 110-2 and 110-3 may set up backhaul BH connection with the gateway AP 110-1. Additionally, the STAs 120 may comprise any proper types of user devices, such as, a computer, a laptop, a smart television, a smart phone and the like. The gateway AP 110-1 may deliver the IPTV data frames to the agent APs 110-2 and 110-3 through backhaul connection. Further, such IPTV data frames may be delivered to the corresponding STAs through fronthaul FH connection.

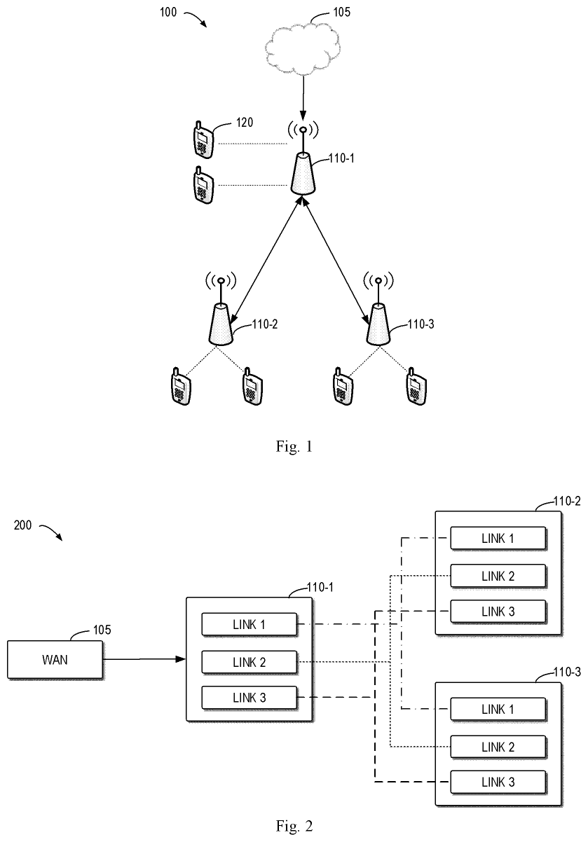

As discussed above, a new feature “multi-link” has been proposed for allowing an AP or a non-AP STA that supports multi-link to simultaneously manage multiple links working on different channels. In some example embodiments, the APs 110 and STAs 120 may be multi-link devices (MLDs). FIG. 2 illustrates a schematic diagram 200 of a multi-link communication in the example communication network. As shown in FIG. 2, the gateway AP 110-1 may establish three links with the agent APs 110-2 and 110-3. As an example, the three links may operate simultaneously in 2.4 GHz, 5 GHz and 6 GHz. As another example, the three links may be also established in the same frequency band.

According to a traditional groupcast solution, the data frames received from the WAN shall be duplicated on all of three links by the gateway AP, which occupies too many radio resources. Further, the issue of BH and FH on the same channel competing the radio resource becomes more serious as the approach of groupcast frame delivery almost exhaust all available radio resource on the set-up links in an easy mesh framework, which cause the throughput of the whole easy mesh network drop linearly.

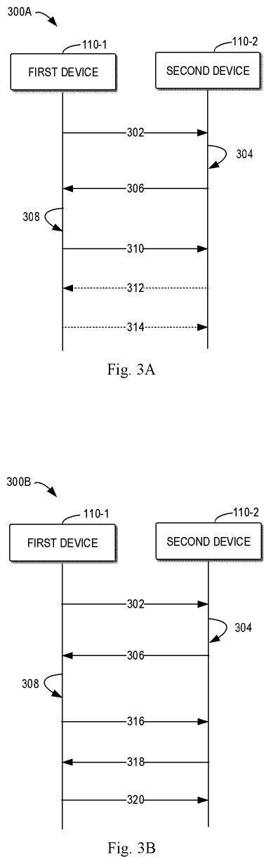

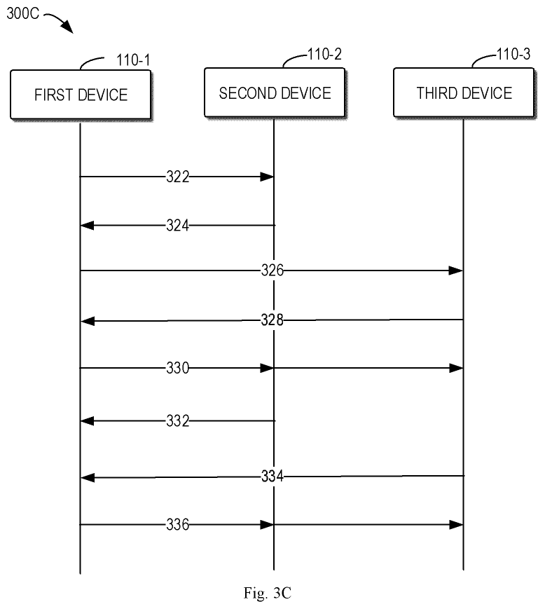

Reference is now made to FIG. 3A, which shows a process 300A for link based groupcast communication according to an example embodiment of the present disclosure. The process 300A may involve a first device and a second device. For the purpose of discussion, the process 300A will be described with reference to FIG. 1. The first device may comprise a gateway AP 110-1, and the second device may comprise an agent AP 110-2 as illustrated in FIG. 1. It would be appreciated that although the process 300A has been described in the communication system 100 of FIG. 1, this process may be likewise applied to other communication scenarios. It would also be appreciated that although the communication between the gateway AP 110-1 and the agent AP 110-2 is discussed, a similar process can be applied for a communication between an AP 110 and a non-AP station 120.

In the process 300A, the first device 110-1 transmits 302 to a second device 110-2 a request comprising a group address of a groupcast stream (also referred to as a group addressed stream) and a first identification, wherein the first identification indicates at least one link among a plurality of links available to first device 110-1. In some example embodiments, both the first device 110-1 and the second device 110-2 may be MLDs.

In some example embodiments, a group address of a groupcast stream may correspond to a source address of the groupcast stream. For example, the group address of the groupcast stream may be a groupcast with retries group address.

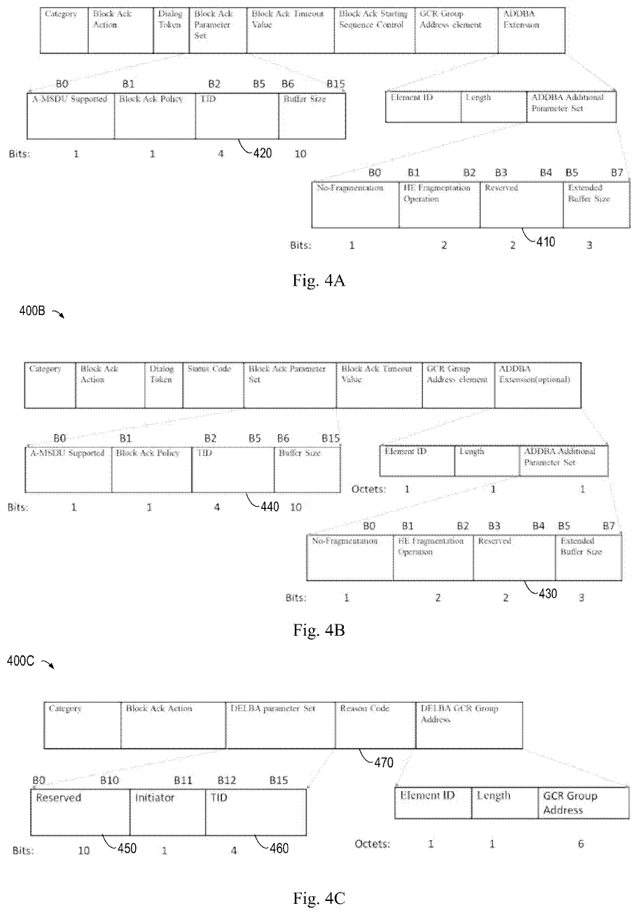

In some example embodiments, the first device 110-1 may transmit a groupcast with retries add block acknowledgement (GCR ADD BA) request to the second device 110-2. For mapping a link to a groupcast stream, the first identification may be contained in the GCR ADD BA request. FIG. 4A illustrates an example structure 400A of a GCR ADD BA request according to some example embodiments of the present disclosure.

In some example embodiments, the first identification indicating at least one link among a plurality of links available to first device may be signaled using at least one bit in the reserved bits 410. For example, two bits in the reserved bits 410 may be used for indicating the first identification, and a value of “00” may correspond to the “LINK 1” that is available to the first device 110-1.

In some further example embodiments, an identification indicating at least one link among a plurality of links available to first device 110-1 may be signaled using at least one bit in a traffic identification (TID) field 420 of the GCR ADD BA request.

In some further example embodiments, at least one extra bit may be contained for signaling the first identification indicating at least one link among a plurality of links available to first device 110-1. For example, a link identification information field may be added at the end of GCR ADD BA request.

In some example embodiments, a bit may also be used for indicating whether the first identification is contained in the GCR ADD BA request. For example, one bit in the reserved bits 410 may be used as a flag indicating whether a link identification is contained in the request.

In some example embodiments, the first identification may indicate one or more corresponding links available to the first device 110-1. Taking FIG. 2 as an example, an identification “00” may indicate “LINK 1”, and an identification “11” may be used to indicate all of the three links. In some further example embodiments, four bits may be used for indicating the first identification, and a range the first identification is 0-15, and a value of 0-14 is corresponding to one link, and a value 15 may indicate that any side drop the preference of link selection and that all of the available links shall be used for the groupcast communication.

Further, in the process 300A, the second device 110-2 determines 304 whether the groupcast stream is mapped to the first identification contained in the request. In some example embodiments, the second device 110-2 may maintain a mapping between a groupcast stream and one or more links. For example, the second device 110-2 may store a value of a link identification in association with a group address of the groupcast stream for indicating the mapping.

The second device 110-2 further transmits 306 to the first device 110-1 a response comprising the group address contained in the request and a second identification indicating at least one link available to the second device 110-2.

In some example embodiments, the second device 110-2 may transmit a GCR ADD BA response to the first device 110-1. Similar to the GCR ADD BA request, the second identification may be signaled using at least bit in the GCR ADD BA response. FIG. 4B illustrates an example structure 400B of a GCR ADD BA response according to some example embodiments of the present disclosure.

In some example embodiments, the second identification may be signaled using at least one bit in the reserved bits 430 of the GCR ADD BA response. In some further example embodiments, the second identification may be signaled using at least one bit in a traffic identification (TID) field 440 of the GCR ADD BA response.

In some further example embodiments, at least one extra bit may be contained for signaling the second identification. For example, a link identification information field may be added at the end of GCR ADD BA response.

In some example embodiments, a bit may also be used for indicating whether the second identification is contained in the GCR ADD BA response. For example, one bit in the reserved bits 430 may be used as a flag indicating whether a link identification is contained in the request.

In some example embodiments, the second identification may indicate one or more corresponding links available to the second device 110-2. Taking FIG. 2 as an example, an identification “00” may indicate “LINK 1”, and an identification “11” may be used to indicate all of the three links. In some further example embodiments, four bits may be used for indicating the second identification, and a range the second identification is 0-15, and a value of 0-14 is corresponding to one link, and a value 15 may indicate that any side drop the preference of link selection and that all of the available links shall be used for groupcast communication.

In some example embodiments, at least one bit may be contained in the GCR ADD BA response for indicating the result of determination. For example, if it is determined by the second device 110-2 that the first identification contained in the request is mapped to the groupcast stream, the Result Code in the GCR ADD BA response is “SUCCESS”, and the second identification is the same as the first identification.

In some example embodiments, if it is determined by the second device 110-2 that the first identification contained in the request is not mapped to the groupcast stream, a particular value of the Result Code may be contained in the GCR ADD BA response.

Further, in the process 300A, the first device 110-1 determines 308 whether the first identification matches the second identification. In some example embodiments, the first device 110-1 may compare a value of the first identification with a value of the second identification contained in the response. If the first and second identifications have a same value, the first device 110-1 may determine that the first identification matches the second identification. Otherwise, the first device 110-1 may determine that the first identification fails to match the second identification.

In some further example embodiments, the first device 110-1 may also determine whether the first identification matches the second identification based on the Result Code contained in the GCR ADD BA response. If the Result Code is equal to “SUCCESS”, the first device 110-1 may determine that the first identification matches the second identification. Otherwise, if the Result Code is equal to a particular value indicating that it is determined by the second device 110-2 that the first identification contained in the request is not mapped to the groupcast stream, the first device 110-1 may determine that the first identification fails to match the second identification.

In accordance with a determination that the first identification matches the second identification, the first device 110-1 transmits to the second device 110-2 the groupcast stream on the at least one link indicated by the first identification.

In some example embodiments, the first device 110-1 may utilize the at least one link indicated by the first identification to transmit the GCR BA data frames to the second device 110-2. As such, the data frames shall not be duplicated on all the available links, and the waste of radio resources caused by repeated transmission of invalid data on the multiple links are reduced significantly.

In some example embodiments, retransmission may be supported. In particular, a block acknowledgement (BA) frame may be sent from the second device 110-2 to the first device 110-1 for indicating whether any data frame is received or not. As shown in FIG. 3A, in accordance with a determination of a failure of receipt of a first frame in the groupcast stream, the second device 110-2 may transmit 312 to the first device 110-1 a BA frame indicating the failure of the receipt of the first frame in the groupcast stream.

Further, the first device 110-1 may transmit 314 at least a first retransmission frame of the first frame to the second device 316 on the at least one link indicated by the first identification. In this way, the retransmission of the data frame shall also be performed only on the link(s) mapped to the groupcast stream.

Reference is now made to FIG. 3B, which shows a process 300B for link based groupcast communication according to an example embodiment of the present disclosure. The steps 302-308 have been described with reference to FIG. 3A.

In accordance with a determination that the first identification fails to match the second identification at step 308, the first device 110-1 may transmit to the second device a second request comprising the group address and the second identification contained in the first response. For example, the first device 110-1 may transmit a GCR ADD BA request comprising the second identification to the second device 110-2.

Further, upon receiving the request, the second device 110-2 may determine that the second identification contained in the request is mapped to the groupcast stream, and may then transmit 318 a second response comprising the group address and the second identification. For example, the second device 110-2 may transmit a GCR ADD BA response comprising the group address and the second identification to the first device, and the Result Code in the response is set as “SUCCESS”.

Additionally, the first device 110-1 may then transmit to the second device 110-2 the groupcast stream on at least one link indicated by the second identification. As such, the link to be used for groupcast may be determined in a negotiation way between the first and second devices.

In some example embodiments, a mapping between a data stream and the link may be configured using a request. In one example, before the step 302, the first device 110-1 may first transmit a groupcast with retries delete block acknowledgement (GCR DEL BA) frame comprising the group address and the first identification to the second device 110-2. Upon receiving the GCR DEL BA frame comprising the group address and the first identification, the second device 110-2 may removes the current BA agreement and remap the groupcast stream to the first identification contained in the GCR DEL BA frame.

FIG. 4C illustrates an example structure 400C of a GCR DEL BA frame according to some example embodiments of the present disclosure. In some example embodiments, the first identification may be signaled using at least one bit in the reserved bits 450 of the GCR DEL BA frame. In some further example embodiments, the first identification may be signaled by reusing at least one bit in the TID field 460 of the GCR DEL BA frame.

In some further example embodiments, the GCR DEL BA frame can be used to remap a groupcast stream and a link only when a particular reason code is contained. For example, a value such as “40” may be used to indicate that the GCR DEL BA frame is configured for remapping a link of the data stream.

Further, the second device 110-2 may then transmit an acknowledgement to the GCR DEL BA frame to the first device 110-1. Upon receiving an acknowledgement to the GCR DEL BA frame from the second device, the first device 110-1 may transmit 302 to the second device 110-2 the GCR ADD BA request comprising the group address and the first identification.

In another example, before the step 302, the second device 110-2 may transmit a GCR DEL BA frame comprising the group address and the first identification to the first device 110-1. Further, the reason code contained in the GCR DEL BA frame may indicate that the GCR DEL BA frame is configured for remapping a link of the data stream.

Upon receiving the GCR DEL BA frame, the first device 110-1 may remap the groupcast stream to the at least one link as indicated by the first identification contained in the GCR DEL BA frame. Further, the first device 110-1 may then transmit an acknowledgement to the GCR DEL BA frame to the second device 110-2. As such, the mapping between the groupcast stream and the link at the first device 110-1 is modified by the second device 110-2. In this case, when a groupcast communication is to be established between the first and second devices, the first device 110-1 may then transmit 302 to the second device 110-2 the GCR ADD BA request comprising the group address and the first identification.

Reference is now made to FIG. 3A, which shows a process 300C for link based groupcast communication according to an example embodiment of the present disclosure. The process 300C may further involve a third device. For the purpose of discussion, the process 300C will be described with reference to FIG. 1. The third device may comprise an agent AP 110-3 as illustrated in FIG. 1.

In the process 300C, the first device 110-1 may transmit 322 to a second device 110-2 a request comprising a first group address of a first groupcast stream and a first identification, wherein the first identification indicates at least one link among a plurality of links available to first device 110-1. The second device 110-2 may further transmit 324 to the first device 110-1 a response comprising the first group address and the first identification.

The first device 110-1 may also transmit 326 to a third device 110-3 a request comprising a second group address of a second groupcast stream and the first identification. The third device 110-3 may further transmit 328 to the first device 110-1 a response comprising the second group address and the first identification. As such, both of the first and second groupcast streams are mapped to the link(s) indicated by the first identification.

The first device 110-1 may further groupcast 330 the first and second data streams to the second device 110-2 and the third device 110-3 for example using GCR BA data frames.

In a case that a first frame in the first groupcast stream is not received by the second device 110-2 and a second frame in the second groupcast stream is not received by the third device 110-3, the second device 110-2 may transmit 332 to the first device 110-1 a BA frame indicating the failure of the receipt of the first frame in the first groupcast stream, and the third device 110-3 may transmit 334 to the first device 110-1 a BA frame indicating the failure of the receipt of second first frame in the second groupcast stream.

The first device 110-1 may then transmit 336 at least a first retransmission frame of the first frame and a second retransmission frame of the second frame to the second and third devices on the at least one link indicated by the first identification. In some example embodiments, the first device 110-1 may determine, based on the received BA frames, a union set of the all the frames which are not received in all of the groupcast streams transmitted on the at least one link indicated by the first identification. Further, the first device 110 may then groupcast a set of retransmission frames of the union set of the all the frames still on the at least one link as indicated by the first identification.

It shall be understood that any of the groupcast processes discussed above may also be applied to the groupcast communication between an AP and one or more non-AP STAs in an infrastructure BSS.

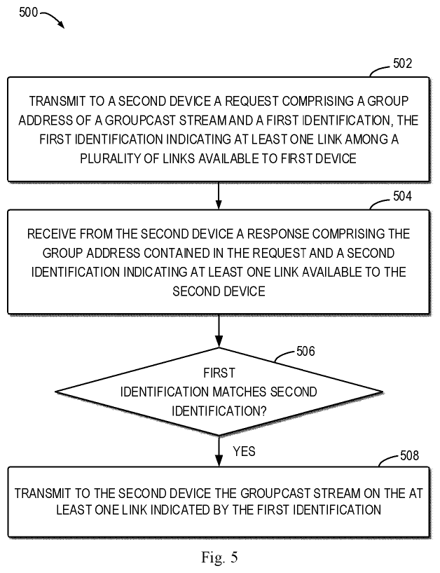

FIG. 5 shows a flowchart of an example method 500 implemented at a first device in accordance with some example embodiments of the present disclosure. For the purpose of discussion, the method 500 will be described from the perspective of the first device 110-1 with reference to FIG. 1.

At block 502, the first device 110-1 transmits to a second device a request comprising a group address of a groupcast stream and a first identification, the first identification indicating at least one link among a plurality of links available to first device. At block 504, the first device 110-1 receives from the second device a response comprising the group address contained in the request and a second identification indicating at least one link available to the second device. At block 506, the first device 110-1 determines whether the first identification matches the second identification. At block 508, in accordance with a determination that the first identification matches the second identification, the first device 110-1 transmits to the second device the groupcast stream on the at least one link indicated by the first identification.

In some example embodiments, the request comprises a first request and the response comprises a first response, and the method 500 further comprises: in accordance with a determination that the first identification fails to match the second identification, transmitting to the second device a second request comprising the group address and the second identification contained in the first response: receiving from the second device a second response comprising the group address and the second identification: and transmitting to the second device the groupcast stream on at least one link indicated by the second identification.

In some example embodiments, the method 500 further comprises: receiving a first block acknowledgement (BA) frame from the second device, the first BA frame indicating a failure of a receipt of a first frame in the groupcast stream: and transmitting at least a first retransmission frame of the first frame to the second device on the at least one link indicated by the first identification.

In some example embodiments, the groupcast stream is a first groupcast stream and the first device further transmits a second groupcast stream to a third device on the at least one link indicated by the first identification, and wherein transmitting at least a first retransmission frame of the first frame to the second device on the at least one link comprises: receiving a second BA frame from the third device, the second BA frame indicating a failure of receipt of a second frame in the second groupcast stream: and transmitting the first retransmission frame of the first frame and a second retransmission frame of the second frame to the second and third devices on the at least one link indicated by the first identification.

In some example embodiments, transmitting to the second device a request comprising the group address and the first identification comprises: transmitting to the second device a groupcast with retries delete block acknowledgement (GCR DEL BA) frame comprising the group address and the first identification: and upon receiving an acknowledgement to the GCR DEL BA frame from the second device, transmitting to the second device a GCR ADD BA request comprising the group address and the first identification.

In some example embodiments, transmitting to the second device a request comprising the group address and the first identification comprises: receiving from the second device a GCR DEL BA frame comprising the group address of the groupcast stream and the first identification; and transmitting to the second device a GCR ADD BA request comprising the group address and the first identification contained in the GCR DEL BA frame.

In some example embodiments, the GCR DEL BA frame comprises a reason code indicating that the GCR DEL BA frame is configured for remapping a link of the data stream.

In some example embodiments, the GCR DEL BA frame comprises a bit indicating that the first identification is contained in the GCR DEL BA frame.

In some example embodiments, the first identification is indicated by at least one bit in a traffic identification (TID) field of the GCR DEL BA frame.

In some example embodiments, the request comprises a groupcast with retries add block acknowledgement (GCR ADD BA) request, and the response comprises a GCR ADD BA response.

In some example embodiments, the GCR ADD BA request comprises a first bit indicating that the first identification is contained in the request; or wherein the GCR ADD BA response comprises a second bit indicating that the second identification is contained in the response.

In some example embodiments, the first identification is indicated by at least one bit in a traffic identification (TID) field of the GCR ADD BA request; or wherein the second identification is indicated by at least one bit in a TID field of the GCR ADD BA response.

In some example embodiments, the first device comprises an access point AP in an infrastructure basic service set BSS or a mesh station in a mesh BSS.

In some example embodiments, the second device comprises a non-AP station in an infrastructure BSS or a mesh station in a mesh BSS.

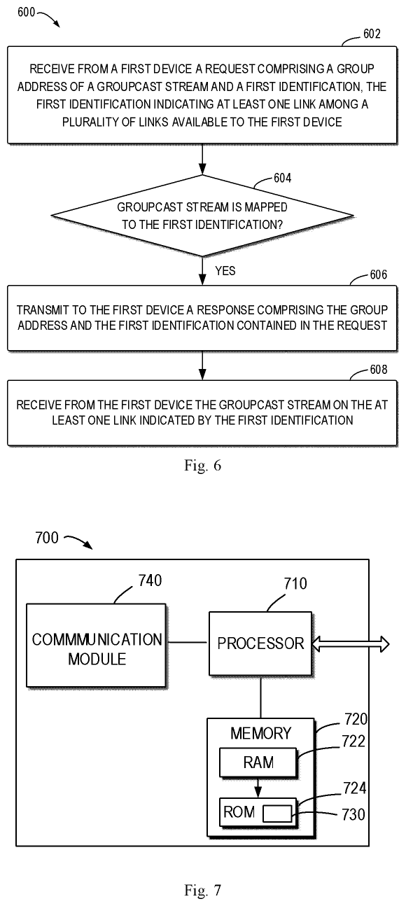

FIG. 6 shows a flowchart of an example method 600 implemented at a second device in accordance with some example embodiments of the present disclosure. For the purpose of discussion, the method 600 will be described from the second device 110-2 with reference to FIG. 1.

At block 602, the second device 110-2 receives from a first device a request comprising a group address of a groupcast stream and a first identification, the first identification indicating at least one link among a plurality of links available to the first device. At block 604, the second device 110-2 determines whether the groupcast stream is mapped to the first identification contained in the request. At block 606, in accordance with a determination that the data stream is mapped to the first identification, the second device 110-2 transmits to the first device a response comprising the group address and the first identification contained in the request. At block 608, the second device 110-2 receives from the first device the groupcast stream on the at least one link indicated by the first identification.

In some example embodiments, the request comprises a third request and the response comprises a third response, and the method 600 further comprises: in accordance with a determination that the groupcast stream is mapped to a third identification different from the first identification contained in the third request, transmitting to the first device a fourth response comprising the group address and the third identification, the third identification indicating at least one link available to the second device: receiving from the first device a fourth request comprising the group address and the third identification contained in the fourth response: transmitting to the first device a fifth response comprising the group address and the third identification contained in the fourth response: and receiving from the first device the data stream on at least one link indicated by the third identification.

In some example embodiments, receiving from a first device a request comprising a group address of a groupcast stream and a first identification comprises: receiving from the first device a groupcast with retries delete block acknowledgement (GCR DEL BA) frame comprising the group address of the groupcast stream and the first identification; transmitting to the first device an acknowledgement to the GCR DEL BA frame: and receiving from the first device a groupcast with retries add block acknowledgement (GCR ADD BA) request comprising the group address and the first identification.

In some example embodiments, receiving from a first device a request comprising a group address of a groupcast stream and a first identification comprises: transmitting to the first device a GCR DEL BA frame comprising the group address of the groupcast stream and the first identification; and receiving from the first device a GCR ADD BA request comprising the group address and the first identification.

In some example embodiments, the GCR DEL BA frame comprises a reason code indicating that the GCR DEL BA frame is configured for remapping a link of the data stream.

In some example embodiments, the GCR DEL BA frame comprises a bit indicating that the first identification is contained in the GCR DEL BA frame.

In some example embodiments, the first identification is indicated by at least one bit in a traffic identification (TID) field of the GCR DEL BA frame.

In some example embodiments, the method 600 further comprises: in accordance with a determination of a failure of receipt of a first frame in the groupcast stream, transmitting to the first device a block acknowledgement (BA) frame indicating the failure of the receipt of the first frame in the groupcast stream; and receiving from the first device a first retransmission frame of the first frame on the at least one link indicated by the first identification.

In some example embodiments, the request comprises a groupcast with retries add block acknowledgement (GCR ADD BA) request, and the response comprises a GCR ADD BA response.

In some example embodiments, the GCR ADD BA request comprises a first bit indicating that the first identification is contained in the request: or wherein the GCR ADD BA response comprises a second bit indicating that the second identification is contained in the response.

In some example embodiments, the first identification is indicated by at least one bit in a traffic identifier (TID) field of the GCR ADD BA request; or wherein the second identification is indicated by at least one bit in a TID field of the GCR ADD BA response.

In some example embodiments, the first device comprises an access point AP in an infrastructure basic service set BSS or a mesh station in a mesh BSS.

In some example embodiments, the second device comprises a non-AP station in an infrastructure BSS or a mesh station in a mesh BSS.

In some example embodiments, an apparatus capable of performing any of the method 500 (for example, the first device 110-1) may comprise means for performing the respective steps of the method 500. The means may be implemented in any suitable form. For example, the means may be implemented in a circuitry or software module.

In some example embodiments, the apparatus comprises means for transmitting to a second device a request comprising a group address of a groupcast stream and a first identification, the first identification indicating at least one link among a plurality of links available to first device: means for receiving from the second device a response comprising the group address contained in the request and a second identification indicating at least one link available to the second device: means for determining whether the first identification matches the second identification: and means for in accordance with a determination that the first identification matches the second identification, transmitting to the second device the groupcast stream on the at least one link indicated by the first identification.

In some example embodiments, the apparatus further comprises means for performing other steps in some example embodiments of the method 500. In some example embodiments, the means comprises at least one processor: and at least one memory including computer program code, the at least one memory and computer program code configured to, with the at least one processor, cause the performance of the apparatus.

In some example embodiments, an apparatus capable of performing any of the method 600 (for example, the second device 110-2) may comprise means for performing the respective steps of the method 600. The means may be implemented in any suitable form. For example, the means may be implemented in a circuitry or software module.

In some example embodiments, the apparatus comprises: means for receiving from a first device a request comprising a group address of a groupcast stream and a first identification, the first identification indicating at least one link among a plurality of links available to the first device: means for determining whether the groupcast stream is mapped to the first identification contained in the request: means for in accordance with a determination that the data stream is mapped to the first identification, transmitting to the first device a response comprising the group address and the first identification contained in the request: and means for receiving from the first device the groupcast stream on the at least one link indicated by the first identification.

In some example embodiments, the apparatus further comprises means for performing other steps in some example embodiments of the method 600. In some example embodiments, the means comprises at least one processor: and at least one memory including computer program code, the at least one memory and computer program code configured to, with the at least one processor, cause the performance of the apparatus.

FIG. 7 is a simplified block diagram of a device 700 that is suitable for implementing example embodiments of the present disclosure. The device 700 may be provided to implement the communication device, for example the AP 110 and the STA 120 in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the memory, e.g., ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIGS. 3-6. The example embodiments of the present disclosure may also be implemented by hardware or by a combination of software and hardware.

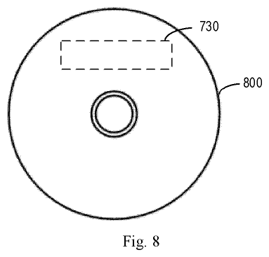

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium 800 has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to FIGS. 3-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-39. (canceled)

40. A method, comprising:
transmitting, at a first device, to a second device a request comprising a group address of a groupcast stream and a first identification, the first identification indicating at least one link among a plurality of links available to first device;
receiving from the second device a response comprising the group address contained in the request and a second identification indicating at least one link available to the second device;
determining whether the first identification matches the second identification; and
in accordance with a determination that the first identification matches the second identification, transmitting to the second device the groupcast stream on the at least one link indicated by the first identification.

41. The method of claim 40, wherein the request comprises a first request and the response comprises a first response, the method further comprising:
in accordance with a determination that the first identification fails to match the second identification, transmitting to the second device a second request comprising the group address and the second identification contained in the first response;
receiving from the second device a second response comprising the group address and the second identification; and
transmitting to the second device the groupcast stream on at least one link indicated by the second identification.

42. The method of claim 40, further comprising:
receiving a first block acknowledgement, BA, frame from the second device, the first BA frame indicating a failure of a receipt of a first frame in the groupcast stream; and
transmitting at least a first retransmission frame of the first frame to the second device on the at least one link indicated by the first identification.

43. The method of claim 40, wherein the first device is an access point, AP, configured to operate in an infrastructure basic service set, BSS, or the first device is a mesh station configured to operate in a mesh BSS.

44. A method, comprising:
receiving, at a second device, from a first device a request comprising a group address of a groupcast stream and a first identification, the first identification indicating at least one link among a plurality of links available to the first device;
determining whether the groupcast stream is mapped to the first identification contained in the request;
in accordance with a determination that the data stream is mapped to the first identification, transmitting to the first device a response comprising the group address and the first identification contained in the request; and
receiving from the first device the groupcast stream on the at least one link indicated by the first identification.

45. The method of claim 44, wherein the request comprises a third request and the response comprises a third response, the method further comprising:
in accordance with a determination that the groupcast stream is mapped to a third identification different from the first identification contained in the third request, transmitting to the first device a fourth response comprising the group address and the third identification, the third identification indicating at least one link available to the second device;
receiving from the first device a fourth request comprising the group address and the third identification contained in the fourth response;
transmitting to the first device a fifth response comprising the group address and the third identification contained in the fourth response; and
receiving from the first device the data stream on at least one link indicated by the third identification.

46. The method of claim 44, wherein receiving from a first device a request comprising a group address of a groupcast stream and a first identification comprises:
receiving from the first device a groupcast with retries delete block acknowledgement, GCR DEL BA, frame comprising the group address of the groupcast stream and the first identification;
transmitting to the first device an acknowledgement to the GCR DEL BA frame; and
receiving from the first device a groupcast with retries add block acknowledgement, GCR ADD BA, request comprising the group address and the first identification.

47. The method of claim 44, wherein receiving from a first device a request comprising a group address of a groupcast stream and a first identification comprises:
transmitting to the first device a GCR DEL BA frame comprising the group address of the groupcast stream and the first identification; and
receiving from the first device a GCR ADD BA request comprising the group address and the first identification.

48. The method of claim 47, wherein the GCR DEL BA frame comprises a reason code indicating that the GCR DEL BA frame is configured for remapping a link of the data stream.

49. The method of claim 44, further comprising:
in accordance with a determination of a failure of receipt of a first frame in the groupcast stream, transmitting to the first device a block acknowledgement, BA, frame indicating the failure of the receipt of the first frame in the groupcast stream; and
receiving from the first device a first retransmission frame of the first frame on the at least one link indicated by the first identification.

50. The method of claim 44, wherein the second device is a non-access point, non-AP, station in an infrastructure basic service set, BSS, or a mesh station in a mesh BSS.

51. A device comprising:
at least one processor; and
at least one memory including computer program codes;
the at least one memory and the computer program codes are configured to, with the at least one processor, cause the device at least to:
transmit to a second device a request comprising a group address of a groupcast stream and a first identification, the first identification indicating at least one link among a plurality of links available to the device;
receive from the second device a response comprising the group address contained in the request and a second identification indicating at least one link available to the second device;
determine whether the first identification matches the second identification; and
in accordance with a determination that the first identification matches the second identification, transmit to the second device the groupcast stream on the at least one link indicated by the first identification.

52. A device comprising:
at least one processor; and
at least one memory including computer program codes;
the at least one memory and the computer program codes are configured to, with the at least one processor, cause the device at least to:
receive from another device a request comprising a group address of a groupcast stream and a first identification, the first identification indicating at least one link among a plurality of links available to the other device;
determine whether the groupcast stream is mapped to the first identification contained in the request;
in accordance with a determination that the data stream is mapped to the first identification, transmit to the other device a response comprising the group address and the first identification contained in the request; and
receive from the other device the groupcast stream on the at least one link indicated by the first identification.

53. The device of claim 52, wherein the request comprises a third request and the response comprises a third response, wherein the device is further configured to:
in accordance with a determination that the groupcast stream is mapped to a third identification different from the first identification contained in the third request, transmit to the other device a fourth response comprising the group address and the third identification, the third identification indicating at least one link available to the device;
receive from the other device a fourth request comprising the group address and the third identification contained in the fourth response;
transmit to the other device a fifth response comprising the group address and the third identification contained in the fourth response; and
receive from the other device the data stream on at least one link indicated by the third identification.

54. The device of claim 52, configured to receive from the other device a request comprising a group address of a groupcast stream and a first identification by:
receiving from the other device a groupcast with retries delete block acknowledgement, GCR DEL BA, frame comprising the group address of the groupcast stream and the first identification;
transmitting to the other device an acknowledgement to the GCR DEL BA frame; and
receiving from the other device a groupcast with retries add block acknowledgement, GCR ADD BA, request comprising the group address and the first identification.

55. The device of claim 52, configured to receive from a first device a request comprising a group address of a groupcast stream and a first identification by:
transmitting to the other device a GCR DEL BA frame comprising the group address of the groupcast stream and the first identification; and
receiving from the other device a GCR ADD BA request comprising the group address and the first identification.

56. The device of claim 54, wherein the GCR DEL BA frame comprises a reason code indicating that the GCR DEL BA frame is configured for remapping a link of the data stream.

57. The device of claim 52, further configured to:
in accordance with a determination of a failure of receipt of a first frame in the groupcast stream, transmit to the other device a block acknowledgement, BA, frame indicating the failure of the receipt of the first frame in the groupcast stream; and
receive from the other device a first retransmission frame of the first frame on the at least one link indicated by the first identification.

58. The device of claim 52, wherein the device is a non-access point, non-AP, station configured to operate in an infrastructure basic service set, BSS, or the device is a mesh station configured to operate in a mesh BSS.

59. A non-transitory computer readable medium comprising program instructions for causing an apparatus to perform at least the method of claim 44.
